(19) United States
(12) Patent Application Publication
(10) Pub. No.: US 2016/0311201 A1
(43) Pub. Date: Oct. 27, 2016

(54) TIRE COMPRISING A MULTILAYER LAMINATED COMPOSITE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: VINCENT ABAD, CLERMONT-FERRAND (FR)

(73) Assignee: Compagnie Generale des Establissements Michelin, Clermont-Ferrand (FR)

(21) Appl. No.: 15/104,407

(22) PCT Filed: Dec. 11, 2014
(86) PCT No.: PCT/EP2014/077321

§ 371 Date: Jun. 14, 2016

(30) Foreign Application Priority Data
Dec. 17, 2013 (FR) 1362810

(51) Int. Cl. B32B 25/04; B32B 25/16; B32B 25/14; B60C 1/00; B32B 25/02

(52) U.S. Cl. CPC B32B 25/042; B60C 1/00; B32B 25/02; B32B 25/14; B32B 25/16; B32B 2605/00

(57) ABSTRACT

A tire comprises an elastomer laminate, said laminate comprising at least two superposed elastomer layers, namely, a first layer, or aromatic polyester-block copolymer (APBC) layer, consisting of a composition based on at least one aromatic polyester-block copolymer (APBC) thermoplastic elastomer, the content of aromatic polyester-block copolymer (APBC) being within a range extending from more than 50 to 100 phr (parts by weight per 100 parts by weight of elastomer) and a second layer, or diene layer, consisting of a composition based on at least one diene elastomer, the content of diene elastomer being in a range extending from more than 50 to 100 phr.

The present invention relates to laminates for tyres comprising a thermoplastic elastomer layer and a diene layer.

In a conventional tyre, the various elastomer layers are composed of diene elastomer compositions, adhering to one another by interdiffusion and creation of bonds during the crosslinking of said elastomers. These layers must therefore be combined before curing (or crosslinking) in order to allow them to adhere.

It is currently of interest for tyre manufacturers to use elastomer layers predominantly comprising, as elastomers, thermoplastic elastomers (TPEs) so as to benefit from the properties of these elastomers, especially for reducing rolling resistance and processability.

The difficulty in using such layers, the elastomers of which are predominantly TPEs, is the adhesion thereof to adjacent diene layers of conventional composition before the curing of the resulting laminate, or after the curing of the layer adjacent to the layer with predominantly TPE elastomers.

In order to improve this adhesion, the applicants have previously described tyre laminates comprising a layer, the elastomers of which are predominantly specific thermoplastic elastomers (TPEs), polystyrene-polyisobutylene block copolymers, for example in the document WO 2010/063427. In this document, the layer predominantly composed of polystyrene-polyisobutylene block copolymers can adhere to a diene layer by the presence of a specific intermediate adhesive layer comprising a specific thermoplastic elastomer (TPE), a styrene-unsaturated elastomer block copolymer. Although it is effective, the resulting laminate is only applicable to a specific example of TPEs.

Document EP 1 987 962 also describes the adhesion of a layer referred to as “thermoplastic elastomer” and a diene layer, by virtue of an adhesive layer comprising a specific thermoplastic elastomer (TPE), a styrene-unsaturated elastomer block copolymer. However, in this document, the layer referred to as “thermoplastic elastomer” is not a layer predominantly composed of TPE but rather a layer composed of a mixture of thermoplastic resin of nylon type on the one hand, and of an elastomer of bromobutyl type on the other hand.

It is still of interest to tyre manufacturers to find a solution to be able to use thermoplastic elastomer layers on diene layers, without needing an adhesion layer. This especially makes it possible to simplify tyre laminates.

At present, the applicants have found that the use of a specific thermoplastic elastomer enables a satisfactory adhesion to the adjacent diene layers, which adhesion is substantially improved relative to the adhesion of layers of other thermoplastic elastomers to the diene layers.

Therefore, a subject of the invention is a tyre comprising an elastomer laminate, said laminate comprising at least two superposed elastomer layers:
a first layer, or aromatic polyester-block copolymer (APBC) layer, consisting of a composition based on at least one aromatic polyester-block copolymer (APBC) thermoplastic elastomer, the content of aromatic polyester-block copolymer (APBC) being within a range extending from more than 50 to 100 phr (parts by weight per 100 parts by weight of elastomer);
a second layer, or diene layer, consisting of a composition based on at least one diene elastomer, the content of diene elastomer being in a range extending from more than 50 to 100 phr.

The first layer, or APBC layer, has excellent adhesion to the second layer, or diene layer, of the tyre of the invention. Compared to the solutions of the prior art, the invention is highly simplified since it makes it possible to adhere a layer composed predominantly of a specific thermoplastic elastomer (TPE), the APBC thermoplastic elastomer, to a diene layer, while dispensing with the need for a specific layer for adhering the thermoplastic elastomer layers to the diene layers.

Preferably, the invention relates to a tyre as defined above, in which the elastomer block of the aromatic polyester-block copolymer (APBC) thermoplastic elastomer of the first layer is selected from the group consisting of polyethers, aliphatic polyesters, polycarbonates and mixtures thereof. Preferably, the aromatic polyester-block copolymer (APBC) thermoplastic elastomer of the first layer is selected from the group consisting of copolymers of aromatic polyester and of polyether and mixtures thereof. More preferentially, the aromatic polyester-block copolymer (APBC) thermoplastic elastomer of the first layer is selected from the group consisting of copolymers of aromatic polyester and of aliphatic polyether and mixtures thereof

Also preferably, the invention relates to a tyre as defined above, in which the number-average molecular weight of the APBC is preferentially between 15 000 and 500 000 g/mol.

Preferentially, the invention relates to a tyre as defined above, in which the aromatic polyester-block copolymer (APBC) thermoplastic elastomer of the first layer has a glass transition temperature (T_{g}) which is less than or equal to 25° C., more preferentially less than or equal to 10° C.

Also preferentially, the invention relates to a tyre as defined above, in which the melting point (Tₘ) of the APBC copolymer is between 140° C. and 210° C.

Preferentially, the invention relates to a tyre as defined above, in which the content of APBC copolymer in the composition of the first layer is within a range extending from 70 to 100 phr, preferably from 80 to 100 phr. More preferentially, the APBC copolymer is the only elastomer of the first layer.

Preferably, the invention relates to a tyre as defined above, in which the first layer does not contain a crosslinking system.

Also preferably, the invention relates to a tyre as defined above, in which the diene elastomer of the second layer is selected from the group consisting of essentially unsaturated diene elastomers, and mixtures of these elastomers; more preferentially from the group consisting of homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof. Very preferentially, the diene elastomer of the second layer is selected from the group consisting of polybutadienes, synthetic polyisoprenes, natural rubber, butadiene copolymers, isoprene copolymers and mixtures of these elastomers.

Preferentially, the invention relates to a tyre as defined above, in which the second layer comprises a reinforcing filler; preferably, the reinforcing filler is carbon black and/or silica. More preferentially, the predominant reinforcing filler is a carbon black.

The invention relates more particularly to tyres as defined above, intended to be fitted on vehicles without an engine such as bicycles, or passenger type motor vehicles, SUVs (Sport Utility Vehicles), two-wheeled vehicles (especially motorcycles), aeroplanes, as well as industrial vehicles chosen from vans, “heavy-duty” vehicles, that is to say underground trains, buses, heavy road transport vehicles (lorries, tractors, trailers), off-road vehicles such as heavy agricultural vehicles or earthmoving equipment, or other transportation or handling vehicles.

The invention and the advantages thereof will be readily understood in light of the following description and exemplary embodiments.

### DETAILED DESCRIPTION OF THE INVENTION

In the present description, unless indicated otherwise, all percentages (%) given are percentages by weight.

Moreover, within the meaning of the present patent application, the term “phr” means parts by weight per hundred parts of elastomer, whether thermoplastic or diene.

Within the meaning of the present invention, thermoplastic elastomers (TPEs) are part of the elastomers.

In addition, any range of values denoted by the expression “between a and b” represents the range of values from more than a to less than b (i.e. limits a and b excluded), while any range of values denoted by the expression “from a to b” means the range of values from a to b (i.e. including the strict limits a and b).

For the purposes of the present invention, it is specified that in the present patent application, “diene layer” denotes an elastomer layer comprising a greater amount by weight of diene elastomer(s) than of elastomer(s) other than diene elastomers, such as thermoplastic elastomers. Also, “APBC layer” denotes a layer consisting of a base composition of at least one aromatic polyester-block copolymer (APBC) thermoplastic elastomer, the content of APBC being in a range extending from more than 50 to 100 phr.

The tyre according to the invention has excellent adhesion between the APBC layer (first layer) and the diene layer (second layer).

The details of the invention will be clarified below, firstly by the description of the laminate of the tyre of the invention, then by the description of the adhesion between the layers and of the use of the laminate of the tyre according to the invention.

### I-Multilayer Laminate

As indicated above, the multilayer laminate of the tyre according to the invention thus has the essential feature of comprising at least two superposed elastomer layers:
a first layer, or aromatic polyester-block copolymer (APBC) layer, consisting of a composition based on at least one aromatic polyester-block copolymer (APBC) thermoplastic elastomer, the content of aromatic polyester-block copolymer (APBC) being within a range extending from more than 50 to 100 phr (parts by weight per 100 parts by weight of elastomer);
a second layer, or diene layer, consisting of a composition based on at least one diene elastomer, the content of diene elastomer being in a range extending from more than 50 to 100 phr.

### I-1. First Layer or APBC Layer

The first layer of the laminate, or aromatic polyester-block copolymer (APBC) layer, consists of a composition based on at least one aromatic polyester-block copolymer (APBC) thermoplastic elastomer, the content of aromatic polyester-block copolymer (APBC) being within a range extending from more than 50 to 100 phr (parts by weight per 100 parts by weight of elastomer).

Thermoplastic elastomers (abbreviated to TPEs) have a structure intermediate between thermoplastic polymers and elastomers. They are block copolymers, consisting of rigid thermoplastic blocks connected by flexible elastomer blocks.

The thermoplastic elastomer used in the adhesion layer for processing the laminate of the tyre of the invention is a block copolymer, the thermoplastic blocks of which are aromatic polyesters, and the elastomer block being variable. By convention, this aromatic polyester-block copolymer thermoplastic elastomer (TPE) is abbreviated to APBC in the present application.

The number-average molecular weight (denoted Mₙ) of the APBC is preferentially between 15 000 and 500 000 g/mol, more preferentially between 20 000 and 300 000 g/mol. Below the minima indicated, there is a risk of the cohesion between the chains of the APBC elastomer chains being affected, especially due to the possible dilution thereof (in the presence of an extender oil); moreover, an increase in the operating temperature risks affecting the mechanical properties, in particular the properties at break, with a consequence of a reduced performance “under hot conditions”. Furthermore, an excessively high Mₙ weight may be detrimental to processing. Thus, it has been found that a value within a range from 20 000 to 50 000 g/mol is particularly well suited, in particular to use of the APBC in an adhesive composition for a multilayer tyre laminate.

The number-average molecular weight (Mₙ) of the APBC is determined by any technique known to those skilled in the art, and especially, in a known manner, by size exclusion chromatography (SEC). The sample is dissolved beforehand in a suitable solvent at a concentration of approximately 2 g/l; then, the solution is filtered through a filter with a porosity of 0.45 μm before injection. The apparatus used is a “Waters alliance” chromatographic chain. For example, in the case of APBCs of COPE type, the elution solvent is hexafluoroisopropanol with sodium trifluoroacetate salt at a concentration of 0.02 M, the flow rate is 0.5 ml/min, the temperature of the system is 35° C. and the analysis time is 90 min. A set of three Phenomenex columns in series, with “Phenogel” trade names (pore size: 10⁵, 10⁴, 10³ Å). The injected volume of the solution of polymer sample is 100 μl. The detector is a “Waters 2410” differential refractometer and its associated software for handling the chromatographic data is the “Empower” system. The calculated average molecular weights are relative to a calibration curve made with PMMA (polymethyl methacrylate) standards. The conditions may be adapted by those skilled in the art.

The polydispersity index Iₚ (as a reminder: Iₚ=M_{w}/Mₙ, where M_{w}=weight-average molecular weight and Mₙ=number-average molecular weight) of the TPE is preferably less than 3; more preferentially less than 2 and even more preferentially less than 1.5.

In the present application, when reference is made to the glass transition temperature of the APBC, this is the T_{g} relative to the elastomer block. The APBC preferentially has a glass transition temperature (T_{g}) which is preferentially less than or equal to 25° C., more preferentially less than or equal to 10° C. A T_{g} greater than these minima may reduce the performance of the multilayer laminate during use at very low temperatures; for such a use, the T_{g} of the TPE is more preferentially still less than or equal to −10° C. Also preferentially, the T_{g} of the APBC is greater than −100° C.

As is known, the APBCs have two glass transition temperature peaks (T_{g} measured according to ASTM D3418); the lower temperature being relative to the elastomer part of the APBC and the highest temperature being relative to the thermoplastic part of the APBC, that is to say to the aromatic polyester block. Thus, the flexible blocks of the APBC are defined by a T_{g} lower than room temperature (25° C.), while the rigid aromatic polyester blocks have a T_{g} greater than 60° C.

The APBCs have, by the thermoplastic blocks thereof, a melting point (Tₘ) (measured by DSC) of greater than 120° C. Preferably, for the purposes of the invention, APBC thermoplastic elastomers with a T. of between 140° C. and 210° C. are preferred for the APBC layer.

APBCs are copolymers comprising a large number of blocks (more than 30, typically from 50 to 500), these blocks preferably having low weights, for example from 500 to 5000 g/mol; these APBCs are referred to as multiblocks and are a repeating elastomer block-thermoplastic block chain.

The expression “aromatic polyester-block copolymer (APBC) thermoplastic elastomers” is intended to mean block copolymer thermoplastic elastomers in which the rigid blocks essentially (that is to say to more than 80% by weight, preferably to more than 90% by weight and more preferentially to more than 99% by weight) consist of aromatic polyester (that is to say one or more aromatic polyester(s)).

Preferentially, the elastomer block of the APBCs is selected from the group consisting of polyethers, aliphatic polyesters, polycarbonates and mixtures thereof.

Even more preferentially, the elastomer block of the APBCs is selected from the group consisting of polyethers and mixtures thereof, and more preferentially still from the group of aliphatic ethers and mixtures thereof.

In these cases, in which the APBC is a copolymer containing aromatic polyester blocks and polyether blocks, it therefore belongs to the family of the polyester-polyether block copolymers (abbreviated to “COPE”).

For example, mention may be made of the COPEs sold by TOYOBO such as “COPE P30B”, “COPE P40B”, “COPE P40H” or “COPE P55B”. Mention may also be made of the COPE TPE sold by DSM under the name “Arnitel”, or by Dupont under the name “Hytrel”, or by Ticona under the name “Riteflex”.

If any other (non-APBC) elastomers are used in the composition of the APBC layer, the APBC elastomer(s) constitute the predominant fraction by weight; they therefore represent at least 50%, preferentially at least 65%, preferably at least 70% by weight, more preferentially at least 80% by weight of all the elastomers present in the elastomer composition. Also preferentially, the APBC elastomer(s) represent at least 95% (in particular 100%) by weight of all the elastomers present in the elastomer composition of the APBC layer.

Thus, the total amount of APBC elastomer is within a range which varies from more than 50 to 100 phr, preferably from 65 to 100 phr, preferentially from 70 to 100 phr and especially from 80 to 100 phr. Also preferentially, the composition contains from 95 to 100 phr of APBC elastomer. The APBC elastomer(s) are preferentially the only elastomer(s) of the APBC layer.

The APBC elastomer(s) described above are sufficient alone in the APBC layer for the laminate of the tyre according to the invention to be useable.

The composition of the APBC layer according to the invention may nonetheless comprise at least one (that is to say one or more) other elastomer as non-APBC elastomer, this other elastomer being able to be used alone or in a blend with at least one (that is to say one or more) other non-APBC elastomer.

The total content of optional non-APBC elastomer in the composition of the APBC layer is within a range varying from 0 to less than 50 phr, preferentially from 0 to 35 phr, more preferentially from 0 to 30 phr, and especially from 0 to 20 phr. Also preferentially, the composition contains from 0 to 5 phr of non-APBC elastomer. Also preferentially, the composition of the APBC layer according to the invention does not contain any non-APBC elastomer.

The other optional elastomer(s) may be selected from thermoplastic elastomers other than the APBC elastomer, diene elastomers or mixtures thereof.

“Thermoplastic elastomer” (abbreviated to TPE) must be understood, in a manner known to those skilled in the art, as elastomers which have a structure intermediate between thermoplastic polymers and elastomers. They are block copolymers comprising flexible blocks and rigid blocks, as are described for example in document WO 2012/152688.

“Diene” elastomer or rubber must be understood, in a known way, as an (one or more is understood) elastomer derived at least in part (i.e. a homopolymer or a copolymer) from diene monomers (monomers bearing two conjugated or unconjugated carbon-carbon double bonds). These diene elastomers are described in detail in the description of the diene layer below.

This layer may contain, in addition to the elastomer(s), all the customary constituents of rubber compositions, such as fillers, plasticizers, additives and crosslinking agents. These constituents are described below under the optional constituents for the APBC and diene layers of the laminate of the tyre of the invention.

### I-2. Second Layer or Diene Layer

Thus, the diene layer of the multilayer laminate of the tyre according to the invention comprises at least one (that is to say one or more) diene elastomer which may be used alone or in a blend with at least one (that is to say one or more) other diene elastomer (or rubber).

“Diene” elastomer or rubber must be understood, in a known way, as an (one or more is understood) elastomer derived at least in part (i.e. a homopolymer or a copolymer) from diene monomers (monomers bearing two conjugated or unconjugated carbon-carbon double bonds).

These diene elastomers may be classified under two categories: “essentially unsaturated” or “essentially saturated”.

In general, “essentially unsaturated” is understood to mean a diene elastomer derived at least in part from conjugated diene monomers having a content of units of diene origin (conjugated dienes) which is greater than 15% (mol %). In the category of the “essentially unsaturated” diene elastomers, “highly unsaturated” diene elastomer is understood in particular to mean a diene elastomer having a content of units of diene origin (conjugated dienes) which is greater than 50%.

Thus, diene elastomers such as some butyl rubbers or copolymers of dienes and α-olefins of EPDM type may be described as “essentially saturated” diene elastomers (low or very content of units of diene origin, always below 15%).

Having given these definitions, “diene elastomer” capable of being used in the compositions in accordance with the invention is understood to mean, regardless of the above category:

(a) any homopolymer obtained by polymerization of a conjugated diene monomer having from 4 to 12 carbon atoms;
(b) any copolymer obtained by copolymerization of one or more conjugated dienes with one another or with one or more vinylaromatic compounds having from 8 to 20 carbon atoms;
(c) a ternary copolymer obtained by copolymerization of ethylene and of an α-olefin having from 3 to 6 carbon atoms with an unconjugated diene monomer having from 6 to 12 carbon atoms, such as, for example, the elastomers obtained from ethylene and propylene with an unconjugated diene monomer of the abovementioned type, such as, especially, 1,4-hexadiene, ethylidene norbornene or dicyclopentadiene;
(d) a copolymer of isobutene and of isoprene (butyl diene rubber) and also the halogenated versions, in particular chlorinated or brominated versions, of this type of copolymer.

Any type of diene elastomer may be used in the invention. When the composition contains a vulcanization system essentially unsaturated elastomers are preferably used, in particular types (a) and (b) above, to manufacture the multilayer laminate according to the present invention.

As conjugated dienes, 1,3-butadiene, 2-methyl-1,3 -butadiene, 2,3-di(C₁-C₅ alkyl)-1,3-butadienes, such as, for example, 2,3-dimethyl-1,3 -butadiene, 2,3-diethyl-1,3-butadiene, 2-methyl-3-ethyl-1,3-butadiene or 2-methyl-3-isopropyl-1,3-butadiene, aryl-1,3-butadiene, 1,3-pentadiene or 2,4-hexadiene are especially suitable. As vinylaromatic compounds, for example, styrene, ortho-, meta- or para-methyl styrene, the “vinyltoluene” commercial mixture, para-(tert-butyl)styrene, methoxystyrenes, chlorostyrenes, vinylmesitylene, divinylbenzene or vinylnaphthalene are suitable.

The copolymers may contain between 99% and 20% by weight of diene units and between 1% and 80% by weight of vinylaromatic units. The elastomers may have any microstructure which depends on the polymerization conditions used, especially on the presence or absence of a modifying and/or randomizing agent and on the amounts of modifying and/or randomizing agent employed. The elastomers may, for example, be prepared in dispersion or in solution; they may be coupled and/or star-branched or else functionalized with a coupling and/or star-branching or functionalizing agent. For coupling with carbon black, mention may be made, for example, of functional groups comprising a C—Sn bond or of aminated functional groups, such as benzophenone, for example; for coupling with a reinforcing inorganic filler such as silica, mention may be made, for example, of silanol functional groups or silanol-terminated polysiloxane functional groups (as described for example in FR 2 740 778 or U.S. Pat. No. 6,013,718), alkoxysilane groups (as described for example in FR 2 765 882 or U.S. Pat. No. 5,977,238), carboxylic groups (as described for example in WO 01/92402 or U.S. Pat. No. 6,815,473, WO 2004/096865 or US 2006/0089445) or else polyether groups (as described for example in EP 1 127 909 or U.S. Pat. No. 6.503,973). Mention may also be made, as other examples of functionalized elastomers, of elastomers (such as SBR, BR, NR or IR) of the epoxidized type.

As second layer, an elastomer composition is used, the essential feature of which is that it comprises a content of diene elastomer within a range extending from 50 to 100 phr, and especially from more than 50 to 100 phr. Preferably, the content of diene elastomer (that is to say the total content if there are several thereof) is preferentially within a range extending from 55 to 100 phr and more preferentially from 60 to 100 phr. Even more preferentially, the diene layer comprises a total content of diene elastomers within a range extending from more than 95 phr to 100 phr and very preferentially the diene layer comprises 100 phr of diene elastomers which are therefore the only elastomers of the layer.

The diene elastomer(s) described above are therefore sufficient alone in the diene layer for the laminate of the tyre according to the invention to be useable.

The composition of the diene layer according to the invention may nonetheless comprise at least one (that is to say one or more) other elastomer as non-diene elastomer, this other elastomer being able to be used alone or in a blend with at least one (that is to say one or more) other non-diene elastomer.

The total content of optional non-diene elastomer in the composition of the diene layer is within a range varying from 0 to 50 phr, and especially from 0 to less than 50 phr, preferentially from 0 to 45 phr and more preferentially from 0 to 40 phr. Also preferentially, the composition contains from 0 to 5 phr of non-diene elastomer. Also preferentially, the composition of the diene layer according to the invention does not contain any non-diene elastomer.

The other optional elastomer(s) may especially be selected from thermoplastic elastomers or mixtures thereof

“Thermoplastic elastomer” (abbreviated to TPE) must be understood, in a manner known to those skilled in the art, as elastomers which have a structure intermediate between thermoplastic polymers and elastomers. They are block copolymers comprising flexible blocks and rigid blocks, as are described for example in document WO 2012/152688.

This diene layer may contain, in addition to the diene elastomer(s), all the customary constituents of rubber compositions, such as fillers, plasticizers, additives and crosslinking agents. These constituents are described below under the optional constituents for the APBC and diene layers of the laminate of the invention.

### I-3. Optional Constituents for the APBC and Diene Layers of the Multilayer Laminate

The multilayer laminate of the tyre according to the invention has the essential feature of having at least two elastomer layers referred to as “APBC layer” and “diene layer”, having different formulations. Nonetheless, said layers of said multilayer laminate may comprise, in addition to the elastomer constituents specific to them, optional non-essential components, preferentially present or not, among which mention may especially be made of those presented below.

### Nanometric (or Reinforcing) and Micrometric (or Non-Reinforcing) Fillers

The elastomers described above are sufficient alone for the multilayer laminate of the tyre according to the invention to be useable; nonetheless, a reinforcing filler may be used in one or more of the compositions, and especially in the diene layer of the laminate of the tyre of the invention.

When a reinforcing filler is used, any type of filler customarily used for manufacturing tyres may be used, for example an organic filler such as carbon black, an inorganic filler such as silica, or else a blend of these two types of filler, especially a blend of carbon black and silica.

When a reinforcing inorganic filler is used, it is possible, for example, in a known way to use an at least bifunctional coupling agent (or bonding agent) intended to ensure sufficient chemical and/or physical connection between the inorganic filler (the surface of its particles) and the elastomer, in particular bifunctional organosiloxanes or polyorganosiloxanes.

Similarly, the composition of the layers of the multilayer laminate of the tyre of the invention may contain one or more micrometric fillers, referred to as “non-reinforcing” or inert, such as the platy fillers known to those skilled in the art.

### Various Additives

The multilayer laminate of the tyre of the invention may moreover contain the various additives usually present in the elastomer tyre layers known to those skilled in the art. For example, one or more additives will be selected, from protective agents such as antioxidants or antiozonants, UV stabilizers, various processing aids or other stabilizers, or else promoters able to promote adhesion to the rest of the tyre structure. Preferentially, the APBC layer of the multilayer laminate does not contain all these additives simultaneously and preferentially, in certain cases, the APBC layer of the multilayer laminate does not contain any antiozonant, UV stabilizer, processing aid, stabilizer or adhesion promoter.

Also, and optionally, the composition of the layers of the multilayer laminate of the tyre of the invention may contain a crosslinking system known to those skilled in the art. Preferentially, the composition of the APBC layer of the multilayer laminate of the tyre of the invention does not contain a crosslinking system.

Also optionally, the composition of the layers of the multilayer laminate of the tyre of the invention may comprise a plasticizing agent, such as an extender oil (or plasticizing oil) or a plasticizing resin, the function of which is to facilitate the processing of the multilayer laminate, particularly the integration thereof into the tyre by lowering the modulus and increasing the tackifying power.

II-Adhesion of the Layers of the Laminate

It has been observed that the adhesion of the first layer to the second layer in the laminate of the invention is significantly improved compared to the adhesion of a layer of thermoplastic elastomer TPE other than APBC to a diene layer, by virtue of the use of the specific TPE, APBC.

### III-Use and Preparation of the Tyre

The tyre of the invention is manufactured in the usual manner, incorporating laying the laminate of the invention on the various layers of said tyre.

The tyre of the invention may be used in any type of tyre, most particularly in a pneumatic tyre for a motor vehicle, such as a vehicle of two-wheeled, passenger or industrial type, or a non-motorized vehicle such as a bicycle.

The laminate of the tyre of the invention may be manufactured by combining the layers of the laminate, especially before curing.

The multilayer laminate of the tyre of the invention is prepared according to methods known to those skilled in the art, by separately preparing the two layers of the laminate then combining the APBC layer with the diene layer. The APBC layer may be combined with the diene layer under the action of heat and optionally pressure.

### Preparation of the APBC Layer

The APBC layer of the multilayer laminate of the tyre of the invention is prepared conventionally, for example by incorporating the various components in a twin-screw extruder so as to achieve the melting of the matrix and incorporation of all the ingredients, then using a sheet die making it possible to produce the APBC with the desired target thickness. More generally, the APBC may be shaped by any method known to those skilled in the art: extrusion, calendering, extrusion blow-moulding, injection or cast film extrusion.

### Preparation of the Diene Layer

The diene layer of the multilayer laminate of the tyre of the invention is prepared in appropriate mixers, using two successive phases of preparation according to a general procedure well known to those skilled in the art: a first phase of thermomechanical working or kneading (sometimes termed the “non-productive” phase) at high temperature, up to a maximum temperature of between 130° C. and 200° C., preferably between 145° C. and 185° C., followed by a second phase of mechanical working (sometimes termed the “productive” phase) at lower temperature, typically below 120° C., for example between 60° C. and 100° C., during which finishing phase the crosslinking or vulcanization system is incorporated.

According to a preferential embodiment of the invention, all the base constituents of the compositions of the invention, with the exception of the vulcanization system, such as the optional fillers and additives, are incorporated intimately, by kneading, into the diene elastomer during the first, non-productive, phase, that is to say that at least these various base constituents are introduced into the mixer and are thermomechanically kneaded, in one or more steps, until the maximum temperature of between 130° C. and 200° C., preferably of between 145° C. and 185° C., is reached.

By way of example, the first (non-productive) phase is carried out in a single thermomechanical step during which all the necessary constituents, any supplementary covering agents or processing aids and other various additives, with the exception of the vulcanization system, are introduced into an appropriate mixer such as a standard internal mixer. The total duration of the kneading, in this non-productive phase, is preferably between 1 and 15 minutes. After cooling the mixture thus obtained during the first non-productive phase, the vulcanization system is then incorporated at low temperature, generally in an external mixer such as an open mill; everything is then mixed (productive phase) for a few minutes, for example between 2 and 15 min.

The finished composition thus obtained is then calendered, for example in the form of a layer which is referred to in the present invention as “diene layer”.

### Preparation of the Laminate

The multilayer laminate of the tyre of the invention is prepared by combining the

APBC layer with the diene layer, preferably before curing the latter. For adhesion to occur, the temperature at the interface must be greater than the processing temperature of the APBC, which is itself greater than the glass transition temperature (T_{g}) and, in the case of a semicrystalline thermoplastic block, than the melting point (Tₘ) of said APBC, optionally combined with application of pressure.

### IV-Examples

### Preparation of the Examples

The examples of multilayer laminate of the tyre of the invention are prepared as indicated above.

### Description of the Tests Used

The examples of multilayer laminate of the tyre of the invention are tested for adhesion of the APBC layer to the diene layer according to a test referred to as “peel test”.

The peel test specimens are produced by placing the following layers of the laminate in contact: diene layer reinforced with a fabric (so as to limit deformation of said layers under traction)/APBC layer/diene layer reinforced with a fabric. Within this symmetrical stack, an incipient crack is inserted between the APBC layer and one of the adjacent diene layers.

Once assembled, the laminate test specimen is brought to 180° C. under pressure, for 10 minutes. Strips with a width of 30 mm were cut out using a cutting machine. The two sides of the incipient crack were subsequently placed in the jaws of an Instron® tensile testing machine. The tests are carried out at room temperature and at a pull rate of 100 mm/min. The tensile stresses are recorded and are standardized with respect to the width of the test specimen. A curve of force per unit of width (in N/mm) as a function of the mobile crosshead displacement of the tensile testing machine (between 0 and 200 mm) is obtained. The adhesion value selected corresponds to the initiation of failure within the test specimen and therefore to the maximum value of this curve. The performances of the examples are standardized with respect to the control which does not have the APBC layer (base 100). The adhesion value is supplemented by the failure pattern or type of failure: an adhesive pattern means that the adhesive interface was the point of failure, whereas a cohesive pattern reveals cohesion of the material (diene or APBC layer) which is lower than the adhesive strength of the interface, with a point of failure within one of the layers.

### Examples of Laminate

Compositions of diene layer and APBC layer were prepared, assembled and tested as indicated above. The compositions and their combinations and the adhesion results are presented below.

The first layer (layer A) according to the invention (A3 to A5) is an APBC layer, whereas in two control laminates (A1 and A2 respectively), layer A is a diene layer or an SIBS layer. The different layers A are summarized in Table 1 below. The composition of the diene layer (layer B) is presented in Table 2 below.

Three types of laminate are assembled for the purposes of the test: a control laminate with two diene layers, a control laminate comprising a TPE layer other than APBC, in this instance SIBS, and a diene layer, and finally three laminates in accordance with the invention comprising an APBC layer (in this instance COPE) and a diene layer.

The results presented in Table 3 below demonstrate improved adhesive performance of the laminate of the tyre by more than a factor of 5 when the laminate of the tyre of the invention is used (laminates A3/B, A4/B and A5/B), compared with the scenario in which the thermoplastic elastomer layer is a TPE other than an APBC (laminate A2/B). It is also noteworthy that the adhesive performance of the laminate of the tyre of the invention is virtually the same as, or even better than, the ideal scenario in which the two layers of the laminate have an identical composition (laminate A1/B).

TABLE 1

| Layer A | A1 | A2 | A3 | A4 | A5 |
|---|---|---|---|---|---|
| Composition | Diene | SIBS | APBC 1 | APBC 2 | APBC 3 |
| | (1) | (2) | (3) | (4) | (5) |

(1) Diene composition identical to layer B from Table 2
(2) Sibstar 102 T SIBS sold by Kaneka
(3) APBC 1: Pelprene P30B COPE sold by TOYOBO
(4) APBC 2: Pelprene P40B COPE sold by TOYOBO
(5) APBC 3: Pelprene P40H COPE sold by TOYOBO

TABLE 2

| Layer B | Content in phr |
|---|---|
| BR (1) | 15 |
| SBR (2) | 85 |
| N234 (3) | 5 |
| Sil 160MP (4) | 70 |
| Liquid silane (5) | 6 |
| Oil (6) | 2 |
| Resin (7) | 15 |
| Antioxidant (8) | 2 |
| DPG (9) | 1.5 |
| Stearic acid (10) | 2 |
| ZnO (11) | 1 |
| CBS (12) | 2 |
| Sulphur | 1 |

(1) BR, polybutadiene with 4% 1,2 units and 93% 1,4-cis units (T_{g} = −106° C.)
(2) SBR solution, styrene-butadiene copolymer with 26.5% styrene units and 24% 1,2 units of the butadiene part (T_{g} = −48° C.)
(3) ASTM N347 or ASTM N683 grade, sold by Cabot
(4) 160 MP silica, Zeosil 1165MP from Rhodia
(5) Dynasilan Octeo from Degussa
(6) MES oil, Catenex SNR sold by Shell
(7) C5/C9 resin, Escorez 2173 from Exxon
(8) N-(1,3-dimethylbutyl)-N′-phenyl-p-phenylenediamine, 6-PPD from Flexsys
(9) Diphenylguanidine (Perkacit DPG from Flexsys)
(10) Stearine (Pristerene 4931 from Uniqema)
(11) Zinc oxide (industrial grade - Umicore)
(12) N-cyclohexyl-2-benzothiazolesulphenamide, Santocure CBS from Flexsys

TABLE 3

| Laminate | A1/B | A2/B | A3/B | A4/B | A5/B |
|---|---|---|---|---|---|
| Adhesive | 100 | 13 | 109 | 133 | 74 |
| performance | | | | | |
| (%) | | | | | |
| Failure | Cohesive | Adhesive | Cohesive | Cohesive | Adhesive |
| type | | | | | |

1-17. (canceled)

18. A tire comprising an elastomer laminate, said laminate comprising at least two superposed elastomer layers:
a first layer, or aromatic polyester-block copolymer layer, consisting of a composition based on at least one aromatic polyester-block copolymer thermoplastic elastomer, the content of aromatic polyester-block copolymer being within a range extending from more than 50 to 100 phr; and
a second layer, or diene layer, consisting of a composition based on at least one diene elastomer, the content of diene elastomer being in a range extending from more than 50 to 100 phr.

19. The tire according to claim 18, wherein the elastomer block of the at least one aromatic polyester-block copolymer thermoplastic elastomer of the first layer is selected from the group consisting of polyethers, aliphatic polyesters, polycarbonates and mixtures thereof.

20. The tire according to claim 19, wherein the at least one aromatic polyester-block copolymer thermoplastic elastomer of the first layer is selected from the group consisting of copolymers of aromatic polyester, copolymers of polyether and mixtures thereof.

21. The tire according to claim 20, wherein the at least one aromatic polyester-block copolymer thermoplastic elastomer of the first layer is selected from the group consisting of copolymers of aromatic polyester, copolymers of aliphatic polyether and mixtures thereof.

22. The tire according to claim 18, wherein the number-average molecular weight of the aromatic polyester-block copolymer is between 15,000 and 500,000 g/mol.

23. The tire according to claim 18, wherein the at least one aromatic polyester-block copolymer thermoplastic elastomer of the first layer has a glass transition temperature (T_{g}) which is less than or equal to 25° C.

24. The tire according to claim 23, wherein the at least one aromatic polyester-block copolymer thermoplastic elastomer of the first layer has a glass transition temperature (T_{g}) which is less than or equal to 10° C.

25. The tire according to claim 18, wherein the melting point (Tₘ) of the aromatic polyester-block copolymer is between 140° C. and 210° C.

26. The tire according to claim 18, wherein the content of aromatic polyester-block copolymer in the composition of the first layer is within a range extending from 70 to 100 phr.

27. The tire according to claim 26, wherein the content of aromatic polyester-block copolymer in the composition of the first layer is within a range extending from 80 to 100 phr.

28. The tire according to claim 18, wherein the aromatic polyester-block copolymer is the only elastomer of the first layer.

29. The tire according to claim 18, wherein the first layer does not contain a crosslinking system.

30. The tire according to claim 18, wherein the diene elastomer of the second layer is selected from the group consisting of essentially unsaturated diene elastomers and mixtures thereof.

31. The tire according to claim 30, wherein the diene elastomer of the second layer is selected from the group consisting of homopolymers obtained by polymerization of a conjugated diene monomer having from 4 to 12 carbon atoms, copolymers obtained by copolymerization of one or more conjugated dienes with one another or with one or more vinyl aromatic compounds having from 8 to 20 carbon atoms, and mixtures thereof.

32. The tire according to claim 31, wherein the diene elastomer of the second layer is selected from the group consisting of polybutadienes, synthetic polyisoprenes, natural rubber, butadiene copolymers, isoprene copolymers and mixtures thereof.

33. The tire according to claim 18, wherein the second layer comprises a reinforcing filler.

34. The tire according to claim 33, wherein the reinforcing filler is carbon black, silica, or a combination thereof.

35. The tire according to claim 34, wherein the predominant reinforcing filler is carbon black.
